(19) United States
(12) Patent Application Publication
(10) Pub. No.: US 2014/0180757 A1
(43) Pub. Date: Jun. 26, 2014

(54) Techniques For Recording A Consumer Shelf Experience

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/723,183

(22) Filed: Dec. 20, 2012

(51) Int. Cl. G06Q 30/02

(52) U.S. Cl. CPC G06Q 30/0201
USPC 705/7.29; 705/26.1; 705/26.9

(57) ABSTRACT

A computer-implemented method is disclosed herein. The method includes the step of recording, with a processing device of a commerce server, video of a product as a consumer is viewing the product in a retail store. The method also includes the step of correlating with the processing device, the video recorded in the recording step with consumer data. The consumer data can be demographic data associated with the consumer or a purchase history of the consumer. The method also includes the step of offering the correlated video and consumer data for sale to the manufacturer of the product.

### BACKGROUND INFORMATION

1. Field of the Disclosure

The present invention relates generally to accumulating data associated with a consumer's response to the display of a product. In particular, examples of the present invention are related to techniques for recording a consumer's shelf experience with a product, the experience of the consumer when assessing a product for purchase.

2. Background

Manufacturers expend significant resources developing product packaging. The packaging of a product can define the final opportunity to convince the consumer to purchase the product. It is even possible that packaging can sometimes prompt a consumer to purchase a product that the consumer does not need. Many purchases occur in response to emotion, especially when a consumer is unsure and must choose between two brands of the same product. Packaging that invokes an emotional response can tip the balance in a purchasing decision.

A manufacturer can also expend significant resources ensuring that its product is ideally positioned in a retail store. Products are often placed on store shelves only after payment of a fee. These fees are known as “slotting fees.”

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustrating an augmented reality device unit that can be applied in some embodiments of the present disclosure.

FIG. 3 is an example block diagram illustration a commerce server that can be applied in some embodiments of the present disclosure.

FIG. 4 is an example screen shot of the display visible with the augmented reality device during shopping in some embodiments of the present disclosure.

FIG. 5 is an example flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Embodiments of the present disclosure can assist in assessing a consumer's shelf experience while shopping in a retail store. A shelf experience can be viewed as the consumer's response and reaction to a product upon seeing the product on a shelf in a retail store. The shelf experience can also be viewed as related to the effects that product packaging and product placement have on the consumer as the consumer is weighing the decision to purchase the product. The shelf experience can be valuable in assessing the effectiveness of the product packaging and placement.

A system according to some embodiments of the disclosure can include a commerce server recording video of a product as a consumer is viewing the product in a retail store. An augmented reality device, such as a head mountable unit for example, can transmit one or more signals containing data as the consumer shops. The one or more signals can contain data that is indicative of a consumer's shelf experience relative to a product offered for sale in the store.

One of the signals transmitted by the augmented reality device can be a video signal. The video signal can include data useful to a manufacturer for assessing the effectiveness of the product's packaging and placement. For example, the video recorded by the commerce server can reveal the amount of time the consumer spent viewing a product. The video can also reveal the amount of time spent viewing a competing, adjacent product. The video can also reveal the movement of the consumer, indicating whether a purchasing decision was made between two products or between more than two products. The video can also reveal whether or not the consumer grasped any product as the purchasing decision was made. All of this data can be viewed as part of the shelf experience of the consumer and can be useful in assessing the effectiveness of product packaging and product placement.

In some embodiments of the present disclosure, the signal received by the commerce server can be a video signal in which one or more products disposed on shelf are visible. The video signal can be processed using known video recognition/analysis techniques and algorithms to identify a product that is visible in the video. The identified product can be correlated with consumer data to render the video more useful in assessing the consumer's shelf experience with the product. For example, the video can be correlated to the consumer's age or gender or both. In some embodiments of the present disclosure, the video can be correlated to a purchase history of the consumer. The purchase history can be up-to-date, including whether or not the product was purchased at the time the video was recorded. The purchase history can also indicate whether the consumer was a first-time purchaser or had purchased the product before.

The video correlated with the consumer data can be offered for sale to the manufacturer of the product. The correlated video can be desirable for purchase since the correlated video can indicate whether or not the product packaging and/or the product placement is as effective as desired. The correlated video can indicate the basis for any shortcomings in product packaging and/or placement. For example, the correlated video can indicate that the product packaging is not provoking consumers to grasp and inspect the product. The correlated video can also be offered for sale to parties different from the manufacturer of the product.

In some embodiments of the present disclosure, the head mountable unit can transmit more than one signal that is received by the commerce server. The video transmitted by the head mountable unit can be processes to identify a product that is being considered for purchase, but other signals can be processed to complement the video analysis. The location of the head mountable unit as the video is being recorded can be correlated with the information in a product database. For example, as the video is being recorded the commerce server can also receive a position signal from the head mountable unit. The position signal can be correlated with data in a product database that contains the identities and locations of products offered for sale in the retail store. For example, a subset of all products in the retail store can be determined in response to the position signal; the subset of possible products visible in the video would only include products proximate to the head mountable unit based on the position signal.

In some embodiments of the present disclosure, the identity of the product can be at least partially determined in response to a direction signal transmitted by the head mountable unit. The direction of the consumer can be contained in the direction signal emitted by the head mountable unit and received by the commerce server. The data in the direction signal can be correlated to data in the product database to narrow the set of possible products that is visible in the video. The correlation of the position and direction signals to the location of video recording can significantly narrow the set of possible products visible in the video from all of the products offered for sale in the retail store to only products proximate to the head mountable unit and, further, only products in the forward direction of the consumer.

In some embodiments of the present disclosure, the identity of the product can be determined in part by also correlating an orientation signal with the video signal data. For example, the identity of the product of being recorded can be at least partially determined by the position signal, the direction signal, and an orientation signal transmitted by the head mountable unit. The orientation of the consumer's head can be contained in the orientation signal emitted by the head mountable unit and received by the commerce server. The data in the orientation signal, the direction signal, and the position signal can be correlated to data in the product database to narrow the field of possible products that is visible in the video. The orientation signal can indicate that the consumer is viewing a low shelf, a middle shelf, or a high shelf. The video images being recorded correspond to the orientation of the consumer's head. This correlation can significantly narrow the set of possible products that is visible in the video from all the products offered for sale in the retail store to only products proximate to the head mountable unit, only products in the forward direction of the consumer, and only products on a particular shelf.

In some embodiments, the identity of the product can be determined primarily by the video signal. For example, the commerce server can analyze the video signal to identify a bar code visible in the video signal. Alternatively, the product database can include image data of each product offered for sale in the retail store. The commerce server can compare the images in the video signal with images in the product database to determine the identity of a product in the video.

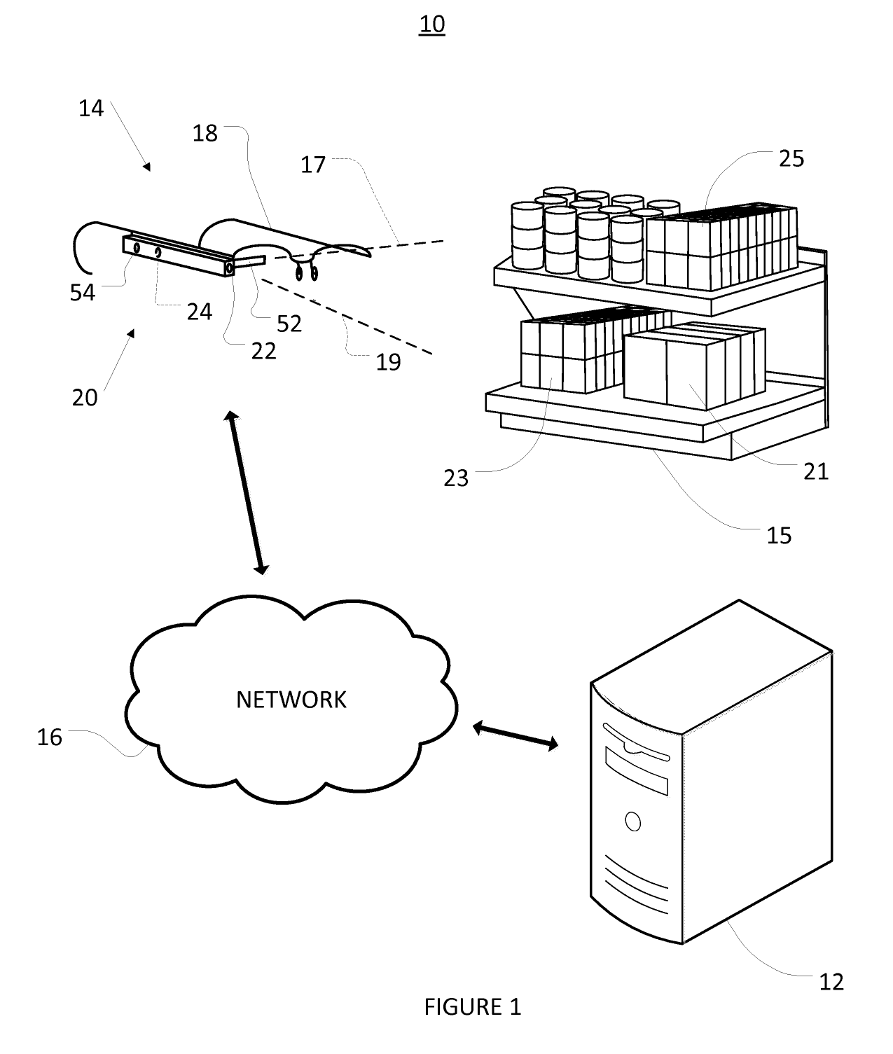

To illustrate, FIG. 1 is a schematic illustrating a video monitoring system 10 according to some embodiments of the present disclosure. The video monitoring system 10 can implement a computer-implemented method that includes the step of recording, with a commerce server 12, video of a product as a consumer is viewing the product in a retail store. The recorded video can be received as a video signal from an augmented reality device such as a head mountable unit 14. The head mountable unit 14 can be worn by a consumer while shopping within a retail store. In the illustrated embodiment of FIG. 1, the exemplary head mountable unit 14 includes a frame 18 and a communications unit 20 supported on the frame 18.

A video signal can be transmitted from the head mountable unit 14 in which a portion of store shelving 15 is in the field of view of a camera 22 of the head mountable unit 14. It is noted that embodiments of the present disclosure can be practiced in retail stores not using shelving and in retail stores partially using shelving.

The field of view of a camera 22 is illustrated schematically by dashed lines 17 and 19. The dashed lines 17 and 19 represent edges of the field of view of the camera 22. One or more products, such as products 21, 23, and 25, can be disposed on the shelving 15 within the field of view of the camera 22.

The one or more signals transmitted by the head mountable unit 14 and received by the commerce server 12 can be transmitted through a network 16. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

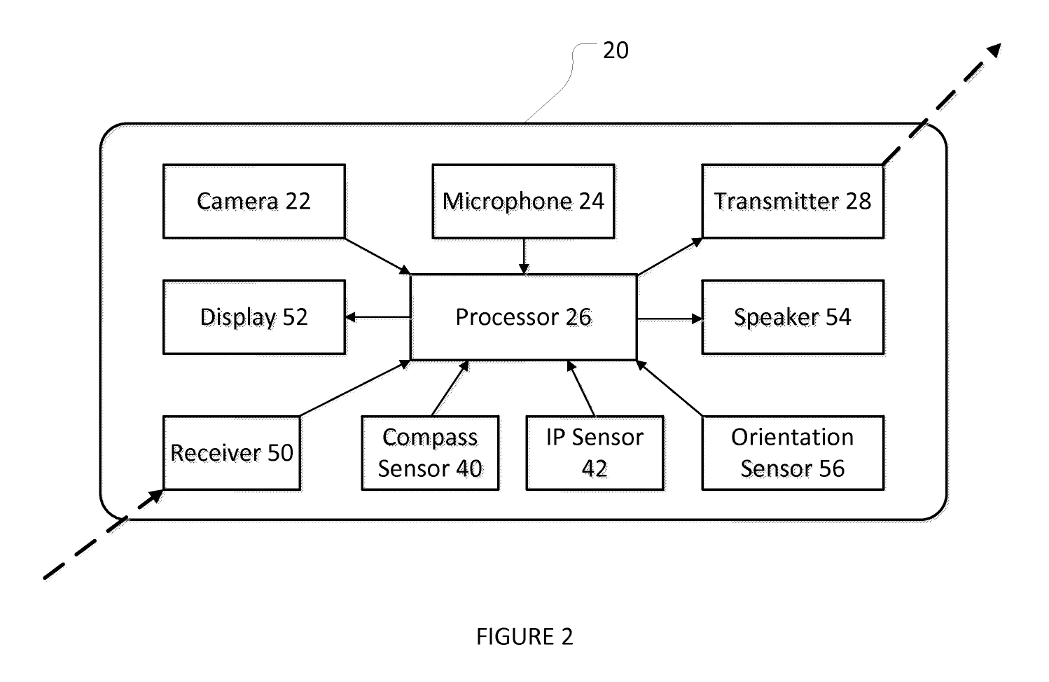

Referring now to FIG. 2, a block diagram illustrating exemplary components of the communications unit 20 includes the camera 22 configured to generate a video signal that corresponds to the field of view of the consumer wearing the head mountable unit 14. The video signal can be processed by the commerce server 12 to determine the identities of the products visible in the images of the video signal. The video signal can also be recorded by the commerce server 12.

The communications unit 20 can also include a microphone 24 configured to generate an audio signal that corresponds to sound generated by and/or proximate to the consumer. The audio signal can be processed in some embodiments of the present disclosure to allow the consumer to assist in conveying the shelf experience associated with a product. For example, verbal signals can be processed by the commerce server 12 such as “this product appears interesting.” Such audio signals can be correlated to the video recording.

The communications unit 20 can also include a processor 26 operable to receive signals generated by the other components of the communications unit 20. The processor can also be operable to control the other components of the communications unit 20 and also to process signals received by the head mount unit 14.

The communications unit 20 can also include a transmitter 28 configured to transmit signals generated by the other components of the communications unit 20 from the head mountable unit 14. The communications unit 20 can also include a compass sensor 40 configured to generate a direction signal that is indicative of the direction that the consumer is facing. The direction signal can be processed to assist in determining the identity of a product visible in the video recorded by the commerce server 12.

The communications unit 20 can also include an indoor positioning (IP) sensor 42 configured to generate a position signal indicative of the position of the consumer. The position signal can be processed to assist in determining one or more products that are proximate to the consumer and are visible in the video signal. Positioning can be accomplished by radio, ultrasound, infrared, or any combination thereof.

The communications unit 20 can also include a receiver 50 configured to receive signals and direct received signals to the processor 26 for further processing. The communications unit 20 can also include a display 52 configured to display text, graphics, images, illustrations and any other video signals to the consumer. The communications unit 20 can also include a speaker 54 configured to emit sounds, messages, information, and any other audio signal to the consumer.

The communications unit 20 can also include an orientation sensor 56 configured to generate an orientation signal indicative of the orientation of the consumer's head, such as the extent to which the consumer is looking downward, upward, or parallel to the ground. A gyroscope can be a component of the orientation sensor 56. The orientation signal can be processed to assist in determining the identity of a product in the images of the video signal.

The camera 22 is operable to capture single images and/or video and to generate a video signal based thereon. The video signal can correspond to the field of view of the consumer wearing the head mountable unit 14. The microphone 24 (shown in phantom) is operable to capture audio data and generate an audio signal based thereon. The audio signal can correspond to sounds that are proximate to the consumer, including the voice of the consumer wearing the head mountable unit 14.

The processor 26 is operable to receive the video signal from the camera 22 and the audio signal from the microphone 24. While one processor 26 is illustrated, it should be appreciated that the term “processor” can include two or more processors that operate in an individual or distributed manner. The transmitter 28 can be an electrical communication element within the processor 26. In one example, the processor 26 is operable to direct the video and audio signals to the transmitter 28 and the transmitter 28 is operable to transmit the video signal and/or audio signal from the head mountable unit 14, such as to the commerce server 12 through the network 16.

The compass sensor 40 can be configured to sense the direction of the consumer, such as the direction that the consumer wearing the head mountable unit 14 is facing. The compass sensor 40 can electrically communicate a direction signal containing direction data to the processor 26 and the processor 26 can control the transmitter 28 to transmit the direction signal to the commerce server 12 through the network 16.

The indoor positioning sensor 42 can be configured to detect an absolute or relative position of the consumer wearing the head mountable unit 14. The indoor positioning sensor 42 can electrically communicate a position signal containing position data to the processor 26 and the processor 26 can control the transmitter 28 to transmit the position signal to the commerce server 12 through the network 16.

The receiver 50 can be operable to receive transmissions from the network and then communicate the transmissions to the processor 26. The receiver 50 can be an electrical communication element within the processor 26. In some embodiments of the present disclosure, the receiver 50 and the transmitter 28 can be an integral unit.

The display 52 can be positioned within the consumer's field of view. Video content can be shown to the consumer with the display 52. The display 52 can be a transparent when not in use and partially transparent when in use to minimize the obstruction of the consumer's field of view through the display 52.

The speaker 54 can be positioned within the consumer's range of hearing. Audio content transmitted by the commerce server 12 can be played for the consumer through the speaker 54. The receiver 50 can receive the audio signal from the commerce server 12 and direct the audio signal to the processor 26. The processor 26 can then control the speaker 54 to emit the audio content.

The orientation sensor 56 can be a sensor that is operable to detect the orientation of the head mountable unit 14 and thus also detect the orientation of the consumer's head and field of view. The orientation sensor 42 can generate the orientation signal in response to the orientation that is detected and communicate the orientation signal to the processor 26. The orientation of the consumer's head can indicate whether the consumer is viewing a lower shelf, an upper shelf, or a middle shelf.

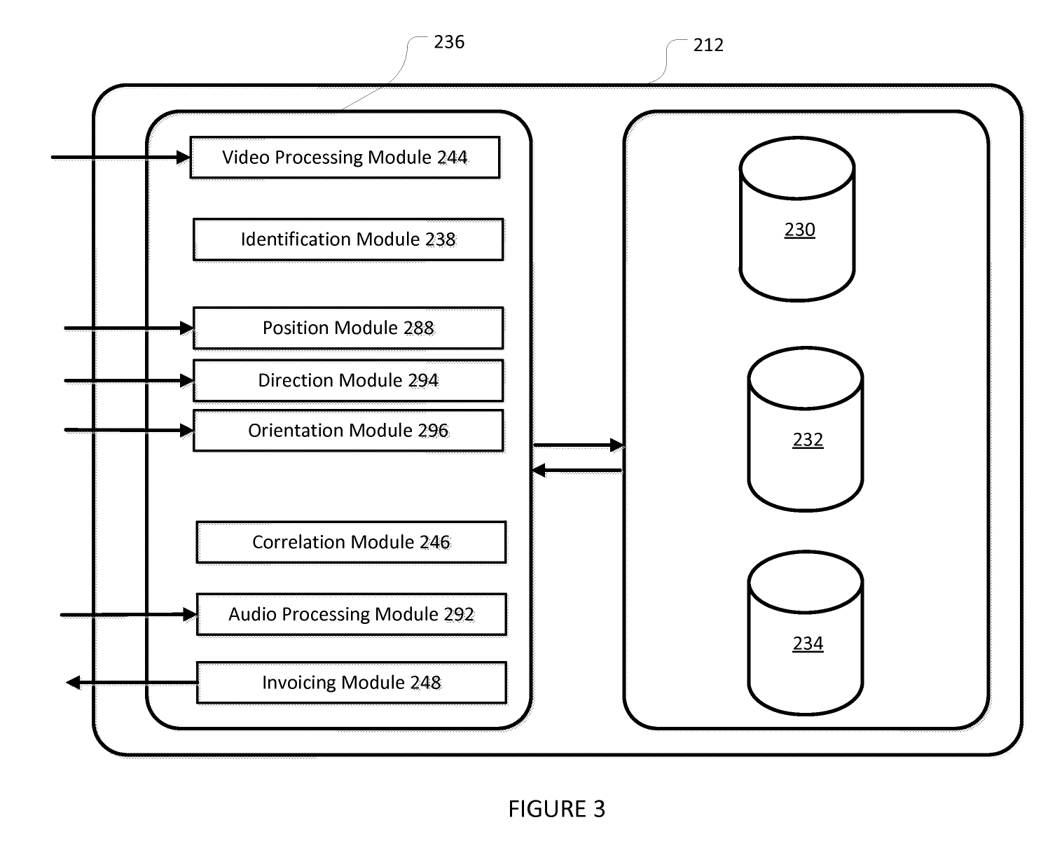

FIG. 3 is a block diagram illustrating a commerce server 212 according to some embodiments of the present disclosure. In the illustrated embodiment, the commerce server 212 can include a product database 230, a recording database 232, and a consumer purchase history database 234. The commerce server 212 can also include a processing device 236 configured to include an identification module 238, a video processing module 244, a correlation module 246, an invoicing module 248, a position module 288, an audio processing module 292, a direction module 294, and an orientation module 296.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

The product database 230 can include in memory the identities of a plurality of products. The plurality of products can be the products offered for sale in a retail store associated with the commerce server 212. The product database 230 can also contain a floor plan of the retail store, including the location of each of the plurality of products within the retail store. The product database 230 can also include image data for each of the products. The data in the product database 230 can be organized based on one or more tables that may utilize one or more algorithms and/or indexes.

The recording database 232 can store video files that are received by the commerce server 212. Each of the video files can be correlated to demographic data associated with the consumer, such as age or age range, and/or gender. Each of the video files can also be correlated to the purchase history of the consumer. The consumer can be identified based on the head mountable unit 14 that is being used in the retail store. Alternatively, the consumer can be identified in response to analysis of the consumer's voice. The data in the recording database 232 can be organized based on one or more tables that may utilize one or more algorithms and/or indexes.

The consumer purchase history database 234 can include in memory purchase histories of consumers, such as a purchase history of the consumer wearing the head mountable unit 14. The data in the consumer purchase history database 234 can be organized based on one or more tables that may utilize one or more algorithms and/or indexes.

The processing device 236 can communicate with the databases 230, 232, 234 and receive one or more signals from the head mountable unit 14. The processing device 236 can include computer readable memory storing computer readable instructions and one or more processors executing the computer readable instructions.

The identification module 238 can be operable to receive a video signal from the camera 22 of the head mountable unit 14. The video processing module 244 can analyze the video signal received from the head mountable unit 14. For example, the video processing module 244 can analyze the video signal for any indication that a product is being considered for purchase and, if so, direct the video of the shelf experience to be recorded in the recording database 232.

The video processing module 244 can implement known video recognition/analysis techniques and algorithms to identify a product on a shelf and/or a product being held by a consumer. The video processing module 244 can also be operable to function cooperatively with the identification module 238. For example, the identification module 238 can receive the analysis of the video signal by the video processing module 244 and, if a product is being considered for purchase, the identification module 238 can determine the identity of the product being considered for purchase. The product that is being considered for purchase is the product that will be the subject of the shelf experience.

In some embodiments, the processing device 236 can also include a position module 288. The position module 288 can be operable to function cooperatively with the identification module 238 to identify the product that is being considered for purchase. The position module 288 can receive the position signal from the head mountable unit 14. The position signal can be generated by the indoor positioning sensor 42 and contain data corresponding to a location of the head mountable unit 14 in the retail store. The position of the consumer can be a factor applied to narrow the set of possible products that is being considered for purchase. The identification module 238 can search the product database 230 based on the position communicated by the position module 288. The identification module 238 can reject products that are not proximate to the consumer. Proximate products can be products immediately in front of the consumer or, products within the field of view of the consumer. Products outside of this range can be dismissed by the identification module 238. For example, products that are in adjacent aisles or further away can be dismissed by the identification module 238.

In some embodiments, the processing device 236 can also include a direction module 294. The direction module 294 can be operable to function cooperatively with the identification module 238 to identify the product that is being considered for purchase. The direction module 294 can receive the direction signal from the head mountable unit 14. The direction signal can be generated by the compass sensor 40 and contain data corresponding to a direction of the head mountable unit 14 in the retail store. The direction of the consumer can be a factor applied to narrow the set of possible products that contains the product that is being considered for purchase. The identification module 238 can search the product database 230 based on the direction communicated by the direction module 294. The identification module 238 can reject products that are not in the forward direction of the consumer as being the product that is being considered for purchase.

In some embodiments, the processing device 236 can also include an orientation module 296. The orientation module 296 can be operable to function cooperatively with the identification module 238 to identify the product that is being considered for purchase. The orientation module 296 can receive the orientation signal from the head mountable unit 14. The orientation signal can be generated by the orientation sensor 40 and contain data corresponding to an orientation of the head mountable unit 14 in the retail store. For example, the orientation of the head mountable unit can be tilted low when the consumer is looking at a lower shelf, tilted high when the consumer is looking at an upper shelf, or level when the consumer is looking at a middle shelf. The orientation of the consumer can be a factor applied to narrow the set of possible products that contains the product that is being considered for purchase. The identification module 238 can search the product database 230 based on the orientation communicated by the orientation module 296. The identification module 238 can reject products that are not on the shelf level indicated by the orientation of the consumer's head. The orientation, direction, and position signals can be received consecutively or concurrently by the processing device 236.

The processing device 236 can include an audio processing module 292. The microphone 24 of the head mountable unit 14 can receive audio signals that can then be transmitted to the processing device 236. The audio processing module 292 can implement known speech recognition techniques to determine that the voice conveyed by the audio signal is likely to correspond to a male or a female. The audio processing module 292 can implement known speech recognition techniques to determine that the voice conveyed by the audio signal is likely to correspond to a particular age or age range. The audio processing module 292 can also identify speech in the audio signal, such as a words or comments that indicate that the consumer has encountered a product of interest. The voice of the consumer can be continuously monitored as the consumer shops in some embodiments of the present disclosure. Any data derived by the audio processing module 292 as a video is being recorded can be correlated or linked to that video.

The processing device 236 can also include a correlation module 246 operable to correlate the video received from the head mountable unit 14 with data associated with the consumer. For example, the correlation unit 236 can be operable to correlate demographic data associated with the customer to the video. The audio processing module 292 can determine the age or age range of the consumer based on an audio signal received from the head mountable unit 14 and the correlation unit 246 can correlate this data with the video recorded as the audio signal is received. The recording database 232 thus contains files in which a video and demographic data are linked. The correlated video and consumer demographic data can be stored in the recording database 232.

The correlation module 246 can also be operable to correlate the video received from the head mountable unit 14 with the purchase history of the consumer. The consumer can be identified based on the head mountable unit 14 being used in the retail store. For example, the head mountable unit 14 can be assigned a unique identifier such as a serial number. The unique identifier of the head mountable unit 14 can thus be associated with a particular consumer. The unique identifier can be communicated to the processing device 236. The correlation unit 236 can search the purchase history database 234 based on the unique identifier and access the consumer's purchase history. Alternatively, the consumer can be identified in response to analysis of the consumer's voice by the audio processing module 292. The correlated video and consumer purchase history data can be stored in the recording database 232. Video can be correlated to demographic data, purchase history data, or both.

The processing device 236 can also include an invoicing module 248. Video correlated to consumer data can be offered for sale, such as to the manufacturer of the product or to others. If the offer is accepted, the invoicing module 294 can generate an invoice to the buyer when the video is recorded.

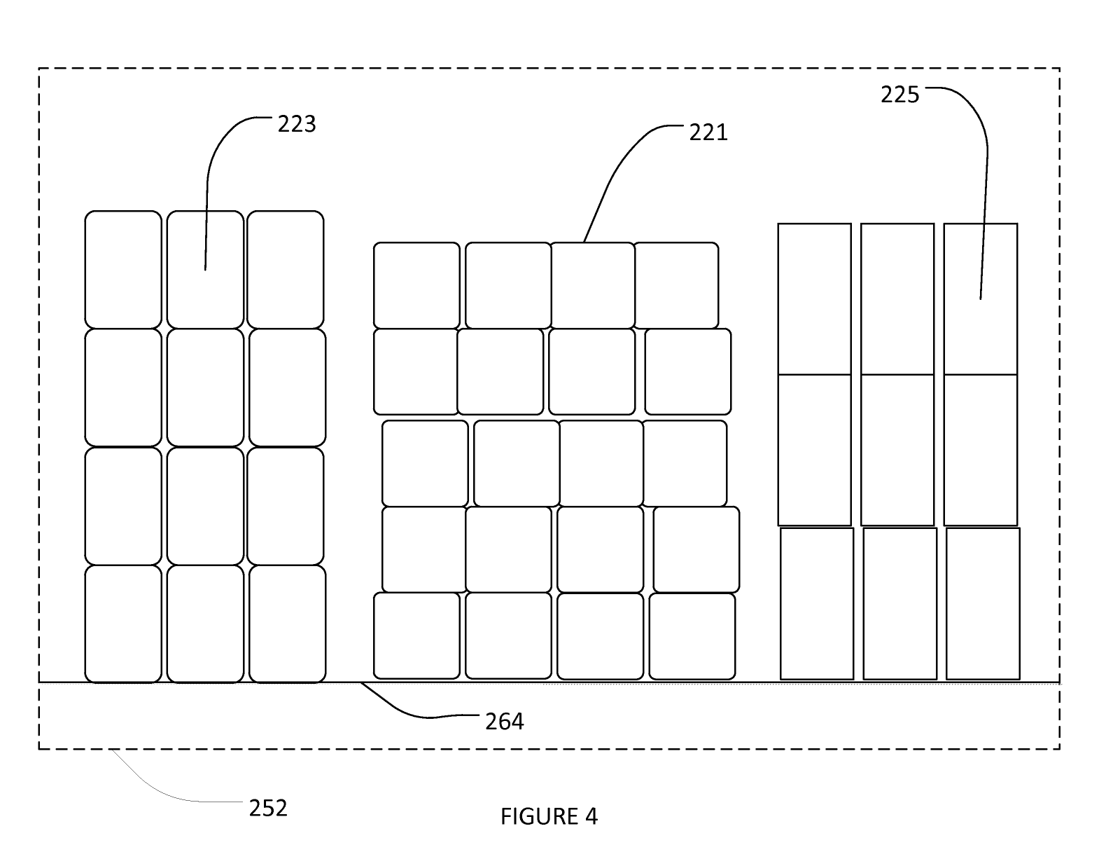

FIG. 4 illustrates a view that can be perceived by the consumer and by the video processing module 244 in some embodiments of the present disclosure. The camera 22 and display 52 of the head mountable unit 14 can be generally aligned such that the display 52 overlaps the field of view of the camera 22. In other words, the camera 22 is arranged so that the video signal received by the commerce server 212 is substantially similar to the field of view through the display 52 for the consumer wearing the head mountable unit 14. The perspective of view of the product in the video can be the same as the perspective of view of the consumer.

FIG. 4 is a screen shot of a field of view that can be visible to the consumer and also received as a video signal by the video processing module 244. The screen shot can fill the display 252 or can be a portion of the display 252. The consumer can be looking through at least part of the display 252 and viewing products, such as products 221, 223, 225, supported on a shelf 264.

The video recording associated with FIG. 4 can begin when the consumer stops or substantially stops moving in the retail store. The consumer's rate of movement can be determined by the position module 288 by monitoring the rate at which the position of the consumer changes. The recorded video can reveal the consumer scanning the shelf 264, considering which of the products 221, 223, 225 to purchase. The video can also reveal the periods of time that each product 221, 223, 225 is generally centered in the display 252. The center of the display 252 can correspond to the focus of the consumer.

The data correlated to the video can enhance the value of the video. The shelf experience of a product can be found to be significantly different between consumers of different age ranges even though the product may be appropriate for both age ranges. For example, it can be discovered that consumers in an age range of twenty-five to thirty years old tend to focus attention more on one brand of breakfast cereal than consumers in an age range of forty to forty-five years old. Alternatively, the correlated video can reveal that male consumers are more likely to grasp a product that is gender neutral during the shelf experience than female consumers. The behavior of consumers during the shelf experience with a product can be helpful in identifying product packaging and placement that is achieving desired results and product packaging and placement that is not performing as desired. The data correlated to the video can reveal that the consumer did not purchase the product.

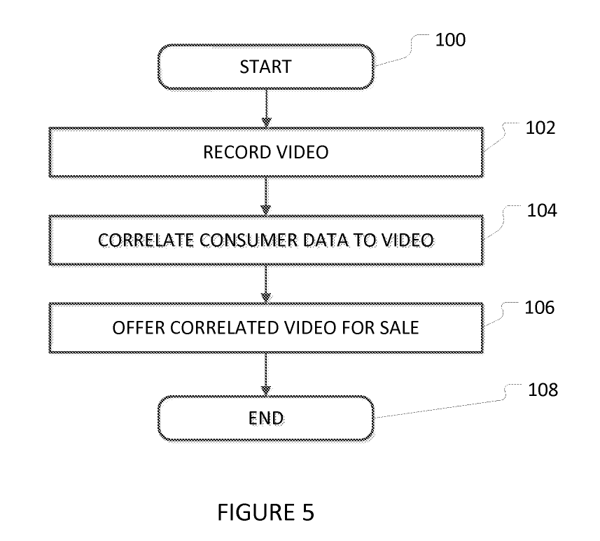

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

FIG. 5 is a flow chart illustrating a method that can be carried out in some embodiments of the present disclosure. The method can be executed by a commerce server. The commerce server can be located at the retail store or can be remote from the retail store. The method starts at step 100. At step 102, the commerce server can record video of a product as a consumer is viewing the product in a retail store. The video can be indicative of a shelf experience for a product being considered for purchase.

At step 104, the video signal is correlated with consumer data being one of demographic data associated with the consumer and a purchase history of the consumer. Examples of demographic data can include age, age range, and/or gender. At operation 106, the correlated video and consumer data can be offered for sale to a manufacturer of the product. In some embodiments, the correlated video can be offered for sale to a party other than the manufacturer of the product. The exemplary method ends at step 112.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

In some embodiments, the consumer can be compensated for the video recorded during shopping. For example, the consumer can be offered coupons or some percentage discount on products purchased during the recorded shopping. In some embodiments, the augmented reality device can be provided to the consumers; consumers can be provided coupons and discounts only available on the augmented reality devices provided by the retail store.

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A method comprising:
recording, with a processing device of a commerce server, video of a product as a consumer is viewing the product in a retail store; and
correlating, with the processing device, the video recorded in said recording step with consumer data being one of demographic data associated with the consumer and a purchase history of the consumer; and
offering the correlated video and consumer data for sale to a manufacturer of the product.

2. The method of claim 1 wherein said recording step further comprises:
recording, with the processing device, video of the product as the consumer is viewing the product with a camera aligned with a perspective of view of the consumer.

3. The method of claim 1 wherein said recording step further comprises:
recording, with a processing device, video of the product received as a video signal from an augmented reality device worn by the consumer.

4. The method of claim 3 further comprising:
receiving, at the processing device, an audio signal from the augmented reality device, wherein said recording step commences in response to said receiving step.

5. The method of claim 3 further comprising:
identifying, with the processing device, the product from among a plurality of products within the retail store, wherein said correlating step is executed in response to said identifying step.

6. The method of claim 1 wherein further comprising:
compensating, with the processing device, the consumer in response to said recording step.

7. The method of claim 1 wherein said correlating step further comprises:
correlating, with the processing device, the video recorded in said recording step with consumer data being demographic data associated with the consumer.

8. The method of claim 7 wherein said correlating step further comprises:
correlating, with the processing device, the video recorded in said recording step with consumer data being an age range of the consumer.

9. The method of claim 7 wherein said correlating step further comprises:
correlating, with the processing device, the video recorded in said recording step with consumer data being a gender of the consumer.

10. The method of claim 1 wherein said correlating step further comprises:
correlating, with the processing device, the video recorded in said recording step with consumer data being the purchase history of the consumer.

11. The method of claim 1 wherein said offering step further comprises:
offering the correlated video and consumer data for sale to a second manufacturer other than the manufacturer of the product.

12. A method comprising:
receiving an offer for sale of a video of a product as a consumer is viewing the product in a retail store correlated with consumer data being one of demographic data associated with the consumer and a purchase history of the consumer; and
accepting the offer of the correlated video and consumer data.

13. A method comprising:
maintaining a product database of the identities and locations of a plurality of products within a retail store;
positioning the plurality of products for sale in the retail store;
recording, with a processing device of a commerce server, video of one of the products as a consumer is viewing the product in the retail store; and
correlating, with the processing device, the video recorded in said recording step with consumer data being one of demographic data associated with the consumer and a purchase history of the consumer; and
offering the correlated video and consumer data for sale.

14. The method of claim 13 further comprising:
generating, with the processing device, an invoice to the manufacturer with the processing device in response to said correlating step.

15. The method of claim 13 wherein said recording step further comprises:
recording, with a processing device, video of the product from a video signal received from a head mountable unit possessed by the consumer.

16. The method of claim 15 further comprising:
providing the head mountable unit to the consumer prior to said recording step.

17. The method of claim 16 further comprising:
processing the video and identifying the product in the video from among the plurality of products in the retail store.

18. The method of claim 17 wherein said processing step includes:
identifying, with the processing device, the product in response at least in part to a position signal received from the head mountable unit.

19. The method of claim 17 wherein said processing step includes:
determining, with the processing device, if the product is being held by the consumer.

20. The method of claim 17 further comprising:
establishing, at the processing device, that the head mountable unit has substantially stopped moving within the retail store before said recording step.
